(19) United States
(12) Patent Application Publication
(10) Pub. No.: US 2011/0105644 A1
(43) Pub. Date: May 5, 2011

(54) TOUGHENED POLY(TRIMETHYLENE TEREPHTHALATE) MOLDING RESINS AND MOLDED ARTICLES THEREFROM

(75) Inventors: Richard T. Chou, Hockessin, DE (US); Toshikazu Kobayashi, Chadds Ford, PA (US)

(73) Assignee: E. I. DU PONT DE NEMOURS AND COMPANY, Wilmington, DE (US)

(21) Appl. No.: 12/916,806

(22) Filed: Nov. 1, 2010

Related U.S. Application Data
(60) Provisional application No. 61/257,113, filed on Nov. 2, 2009.

(51) Int. Cl. C08L 33/02; C08L 67/00; C08K 3/34; C08K 3/26; C08K 3/10

(52) U.S. Cl. 523/219; 524/522; 524/502; 524/445; 524/451; 524/449; 524/456; 524/425; 524/409

(57) ABSTRACT

Poly(trimethylene terephthalate compositions comprising (a) molding resin comprising a poly(trimethylene terephthalate) resin and 0.1 to 4 weight percent of one or more ionomer polymers or a combination of the ionomer polymers and acid copolymers; (b) 0 to about 50 weight percent of one or more fillers, based on the total weight of the molding resin; and (c) about 1.0 to about 5 weight percent of one or more Group A polymeric tougheners based on the total weight of components (a) and (c);

wherein:
each ionomer polymer and acid copolymer has:
C₃ to C₈ carboxylic acid repeat units;
a weight percent, W, based on the weight of components (a) and (c);
a weight fraction of C₃ to C₈ carboxylic acid repeat units, Z, based on the weight of each ionomer or acid copolymer; and
a neutralization ratio, N, ranging in value from 0 to 1.0 and being the mol fraction of the carboxylic acid repeat units neutralized as an
alkali metal salt, based on the total carboxylic acid repeat units in the ionomer polymers and acid copolymers; and
   the molding resin has an alkali carboxylate factor, ACF, ranging from 4 to about 14 and defined by the formula:

ACF=Σₐ₋ᵢ[(W·Z·N)ₐ₋ᵢ(W·N)ₐ₋ᵢ·100/Σₐ₋ᵢ(W)ₐ₋ᵢ]

### CROSS REFERENCE TO RELATED APPLICATIONS

This application claims benefit of priority from U.S. Pat. App. No. 61/257,113, filed 2 Nov. 2009, and currently pending and, which is incorporated in its entirety herein by reference.

### FIELD OF INVENTION

This invention is directed to poly(trimethylene terephthalate) compositions having poly(trimethylene terephthalate)molding resins and a toughener consisting of polyolefins, ethylene copolymers, copolyetherester elastomers, and blends of the polyolefins and the ethylene copolymers and molded articles therefrom.

### BACKGROUND OF INVENTION

Thermoplastic polymer compositions are commonly used to manufacture a wide array of shaped articles for various applications, such as automotive parts, food containers, electrical parts, etc. Shaped articles comprising polyester may be prepared from the molten thermoplastic polymer by several melt extrusion processes, such as injection molding, compression molding, and blow molding.

E. I. du Pont de Nemours & Company (DuPont) developed a way to produce 1,3-propanediol from renewable resources, such as corn sugar. Poly(trimethylene) terephthalate (PTT) resin produced from renewably-sourced 1,3-propanediol is commercially available as Sorona®, which has desirable properties including semi-crystalline molecular structure.

In order to improve the injection molding processsing of thermoplastic polyester compositions, it is desirable to develop a PTT resin containing composition that can be crystallized rapidly from the melt, and at the same time exhibit improved hydrolytic stability.

However, PIT has performance problems when subjected to high crystallization temperatures. PTT has a higher equilibrium cyclic oligomer concentration, typically about 2.5% by weight based on the resin weight, than that of similar polyesters, PET or PBT, which typically have 1.4-1.8% by weight of cyclic oligomer. The most abundant cyclic oligomer of PTT is the cyclic dimer. When PTT resin molded parts are subjected to higher than normal temperature conditions, such as 80° C. to 160° C., the cyclic dimer of PTT is observed to bloom to the surface of the molded part, resulting in an undesirable cosmetic defect. The surface of a black part, that is, carbon black, whitens with a crystalline powder of cyclic dimer. A related problem for polymer compositions containing polyester is that, upon their exposure to heat, they release low molecular weight components, referred to as “outgassing”. Thus, articles made from polyester polymers regularly or constantly subjected to high temperatures experience outgassing. Such articles include lamp bezels, lamp housings, or lamp reflectors, all subject to regular heat of the lamp.

Although U.S. Pat. No. 6,441,129 to Duh et al. discloses a process for making PTT compositions at an increased solid state polymerization rate, it does not disclose the concentration of cyclic oligomer in the PTT made by the process. See also, Duh (2003) J. Appl. Polymer Sci., 89: 3188-3200 [discussing specific solid state polymerization processes] U.S. Pat. No. 7,332,561 discloses a PTT composition in the form of fine particles having a cyclic dimer content of 1.5% by weight or less, and a process for making it.

### SUMMARY OF INVENTION

The technical solution provided herein improves injection molding processing of thermoplastic polyester compositions by adding to such compositions PTT resins that crystallize rapidly from the melt and, consequently, have an alkali carboxylate factor [ACF] ranging from 4 to about 14 and defined by the formula:

ACF=Σₐ₋ᵢ[(W·Z·N)ₐ₋ᵢ(W·N)ₐ₋ᵢ·100/Σₐ₋ᵢ(W)ₐ₋ᵢ].

Described herein are toughened poly(trimethylene terephthalate) compositions comprising:

a poly(trimethylene terephthalate) composition comprising
(a) a molding resin comprising
(a-1) a poly(trimethylene terephthalate) polymer consisting of homopolymer or copolymer;
(a-2) optionally, 0.1 to 20 weight percent of one or more organic additives selected from the group consisting of thermoplastic polymers other than the (a-1) polymer, lubricants, flow modifiers, plasticizers, heat stabilizers, antioxidants, dyes, pigments, and UV stabilizers;
(a-3) 0.1 to 4 weight percent of one or more ionomer polymers or a combination of one or more ionomer polymers and acid copolymers;
   (b) 0 to 50 weight percent of one or more fillers, based on the total weight of the molding resin;
   (c) about 1.0 to 5 weight percent of one or more Group A polymeric tougheners selected from the group consisting of polyolefins, ethylene copolymers, copolyetherester elastomers, and blends of the polyolefins and the ethylene copolymers, based on the total weight of components (a) and (c),
   wherein:
   the ionomer polymers and the acid copolymers have C₃ to C₈ carboxylic acid repeat units; each ionomer polymer and acid copolymer has
a weight percent, W, based on the weight of components (a) and (c);
a weight fraction of C₃ to C₈ carboxylic acid repeat units, Z, based on the weight of each ionomer polymer or acid copolymer; and
a neutralization ratio, N, equal to any value from 0 to 1.0 and being the mole fraction of the carboxylic acid repeat units neutralized as an alkali metal salt, based on the total carboxylic acid repeat units in the ionomer polymers and the acid copolymers;
   the molding resin has an alkali carboxylate factor, ACF, of 4 to about 14; and the ACF is defined by the formula:

ACF=Σₐ₋ᵢ[(W·Z·N)ₐ₋ᵢ(W·N)ₐ₋ᵢ·100/Σₐ₋ᵢ(W)ₐ₋ᵢ].

Also described herein are processes for making the compositions as well as molded articles comprising them.

### BRIEF DESCRIPTION OF THE FIGURES

The compositions, processes, and articles described herein are illustrated by way of the following Figures:

FIG. 1 shows a DSC scan of a melt quenched sample of a commercial PTT resin without added ionomer or acid polymer compositions.

FIG. 2 shows a composition described herein, which has an alkali carboxylate factor [ACF] of 5.22 and the recrystallization exotherm (100) is less than 5 J/g.

FIG. 3 shows a comparative example composition, wherein the thermoplastic composition has an ACF of 2.6 and the recrystallization exotherm (100) is about 11.4 J/g.

FIG. 4, shows a thermoplastic composition having an ACF of 5.22 and 1.5 wt % non-interfering toughener and the recrystallization exotherm (100) is less than 5 J/g.

### DETAILED DESCRIPTION

### Definitions and Abbreviations

The terms of the claims and the specification are to be construed using the definitions and abbreviations provided herein. Used herein are the following abbreviations:

“%” refers to the term percent.

“wt %” refers to weight percent.

“mol %” or “mole %” refers to mole percent.

“ASF” refers to alkali carboxylate factor.

“MFR” refer to melt flow rate.

“NMR” refers to nuclear magnetic resonance.

“(W·Z·N)ₐ₋ᵢ” refers to alkali carboxylate level.

“(W·N)ₐ₋ᵢ/Σₐ₋ᵢ(W)ₐ₋ᵢ” refers to the weight averaged neutralization ratio of the PTT composition.

Used herein are the following definitions:

As used herein, the article “a” indicates one as well as more than one and does not necessarily limit its referent noun to the singular.

As used herein, the terms “about” and “at or about” mean that the amount or value in question may be the value designated or some other value approximately or about the same. The term is intended to convey that similar values promote equivalent results or effects recited in the claims.

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present).

As used herein, the term “consisting essentially of” refers to an exclusive inclusion ONLY for these elements necessary to impart patentability of the claim. For example, a process, method, article, or apparatus that comprises a list of elements may, for those elements not imparting patentability to the claim, include other elements not expressly listed or inherent. However, such a process, method, article, or apparatus DO NOT, for those elements that impart patentability to the claim, include other elements not expressly listed or inherent.

As used herein, the term “consisting of” refers to an exclusive inclusion. For example, a process, method, article or apparatus may NOT include other elements not expressly listed or inherent.

As used herein, the term “poly(trimethylene terephthalate) homopolymer” refers to any polymer consisting essentially of repeat units of trimethylene terephthalate.

As used herein, the term “poly(trimethylene terephthalate) copolymer” refers to any polymer comprising, or derived from, at least about 80 mole percent trimethylene terephthalate and the remainder of the polymer being derived from monomers other than terephthalic acid and 1,3-propanediol, or their ester forming equivalents.

As used herein, the term “copolymer” refers to polymers comprising copolymerized units resulting from copolymerization of two or more comonomers. “Dipolymer” refers to polymers consisting essentially of two comonomer-derived units and “terpolymer” means a copolymer consisting essentially of three comonomer-derived units.

As used herein, the term “ionomer” refers to a polymer that comprises ionic groups that are alkali metal ion carboxylates, for example, sodium carboxylates. Such polymers are generally produced by partially or fully neutralizing the carboxylic acid groups of precursor acid copolymers, as defined herein, for example by reaction with a base. An example of an alkali metal ionomer is a sodium ionomer (or, sodium neutralized ionomer), for example a copolymer of ethylene and methacrylic acid wherein all or a portion of the carboxylic acid groups of the copolymerized methacrylic acid units are in the form of sodium carboxylates.

As used herein, the term “acid copolymer” refers to a polymer comprising copolymerized units of an α-olefin, an α,β-ethylenically unsaturated carboxylic acid, and optionally other suitable comonomer(s) such as, an α,β-ethylenically unsaturated carboxylic acid ester.

As used herein, the terms “(meth)acrylic” and “(meth)acrylate” refer to acrylic acid and methacrylic acid, and esters of acrylic acid and methacrylic acid, respectively.

As used herein, the term “alkali carboxylate factor”[ACF] refers to a mathematical relationship between the weight percent of the alkali carboxylate and that of the ionomer polymer or acid copolymer, if present, ACF in the compositions described herein and is given by the formula: ACF=Σₐ₋ᵢ[(W·Z·N)ₐ₋ᵢ(W·N)ₐ₋ᵢ·100/Σₐ₋ᵢ(W)ₐ₋ᵢ], where
weight percent, W, is based on the weight of components (a) and (c) in these compositions;
a weight fraction of C₃ to C₈ carboxylic acid repeat units, Z, is based on the
weight of each ionomer polymer or acid copolymer; and
a neutralization ratio, N, equal to any value from 0 to 1.0 and being the mole fraction of the carboxylic acid repeat units neutralized as an alkali metal salt, based on the total carboxylic acid repeat units in the ionomer polymers and the acid copolymers.

### Overview

Described herein are toughened poly(trimethylene terephthalate) compositions comprising

(a) a molding resin comprising
(a-1) a poly(trimethylene terephthalate) polymer consisting of a homopolymer or copolymer;
(a-2) optionally, 0.1 to 20 weight percent of one or more organic additives selected from the group consisting of thermoplastic polymers other than the (a-1) polymer, lubricants, flow modifiers, plasticizers, heat stabilizers, antioxidants, dyes, pigments, and UV stabilizers;
(a-3) 0.1 to 4 weight percent of one or more ionomer polymers or a combination of one or more ionomer polymers and acid copolymers;
   (b) 0 to about 50 weight percent of one or more fillers, based on the total weight of the molding resin; and
   (c) about 1.0 to about 5 weight percent of one or more Group A polymeric tougheners selected from the group consisting of polyolefins, ethylene copolymers, copolyetherester elastomers, and blends of the polyolefins and the ethylene copolymers, based on the total weight of components (a) and (c),
   wherein:
   the ionomer polymers and acid copolymers have C₃ to C₈ carboxylic acid repeat units, each ionomer polymer and acid copolymer has

a weight percent, W, based on the weight of components (a) and (c);

a weight fraction of C₃ to C₈ carboxylic acid repeat units, Z, based on the weight

of each ionomer polymer or acid copolymer; and

a neutralization ratio, N, equal to any value from 0 to 1.0 and
being the mol fraction of the carboxylic acid repeat units neutralized as an alkali metal salt, based on the total carboxylic acid repeat units in the ionomer polymer and acid copolymers;
   the molding resin has an alkali carboxylate factor, ACF, of 4 to about 14; and the ACF is defined by the formula:

ACF=Σₐ₋ᵢ[(W·Z·N)ₐ₋ᵢ(W·N)ₐ₋ᵢ·100/Σₐ₋ᵢ(W)ₐ₋ᵢ].

### Compositions

The toughened poly(trimethylene terephthalate) [“PTT”] compositions described herein comprise a molding resin; b) one or more fillers; and c) one or more Group A polymeric tougheners.

### (a) Molding Resin

Molding resin (a) in these compositions comprises:
(a-1) a poly(trimethylene terephthalate) polymer;
(a-2) optionally, 0.1 to 20 weight percent of one or more organic additives selected from the group consisting of thermoplastic polymers other than the (a-1) polymer, lubricants, flow modifiers, plasticizers, heat stabilizers, antioxidants, dyes, pigments, and UV stabilizers; and
(a-3) 0.1 to 4 weight percent of one or more ionomer polymers or a combination of one or more ionomer polymers and acid copolymers.

(a-1) Poly(trimethylene terephthalate) [“PTT”] Polymer

The PTT polymer in these compositions may be a PTT homopolymer, a PTT copolymer and/or a combination of PTT homopolymer and PTT copolymer. A PTT homopolymer is substantially derived from the polymerization of 1,3-propanediol with terephthalic acid, or alternatively, derived from the ester-forming equivalents thereof (e.g., any reactants which may be polymerized to ultimately provide a polymer of poly(trimethylene terephthalate). Most preferably, the molding resin described herein comprises poly(trimethylene terephthalate) homopolymer.

A PTT copolymer refers to any polymer comprising, or derived from, at least about 80 mole percent trimethylene terephthalate and the remainder mole percent derived from monomers other than terephthalic acid and 1,3-propanediol or their ester forming equivalents. Examples of poly(trimethylene terephthalate) copolymers include copolyesters synthesized from 3 or more reactants, each reactant having two ester forming groups.

For example, a poly(trimethylene terephthalate) copolymer may be prepared by reacting 1,3-propanediol, terephthalic acid, and one or more comonomers selected from: (1) linear, cyclic, and branched aliphatic dicarboxylic acids having 4 to 12 carbon atoms, such as butanedioic acid, pentanedioic acid, hexanedioic acid, azelaic acid, sebacic acid, dodecanedioic acid, 1,4-cyclohexanedicarboxylic acid, or ester-forming equivalents of these;

from: (2) aromatic dicarboxylic acids other than terephthalic acid having 8 to 12 carbon atoms, such as phthalic acid, isophthalic acid or 2,6-naphthalenedicarboxylic acid;
from: (3) linear, cyclic, and branched aliphatic diols other than 1,3-propanediol having 2 to 8 carbon atoms, such as ethanediol, 1,2-propanediol, 1,4-butanediol, hexamethylene glycol, 3-methyl-1,5-pentanediol, 2,2-dimethyl-1,3-propanediol, 2-methyl-1,3-propanediol, cyclohexane dimethanol or 1,4-cyclohexanediol; and
from: (4) aliphatic and aromatic ether glycols having 4 to 10 carbon atoms, such as hydroquinone bis(2-hydroxyethyl)ether.

Alternatively, a poly(trimethylene terephthalate) copolymer may be prepared from a poly(ethylene ether) glycol having a molecular weight below about 460, such as diethylene ether glycol, methoxypolyalkylene glycol, diethylene glycol, and polyethylene glycol.

The comonomer may be present in the copolymer at a level of about 0.5 to about 20 mol %, and may be present at a level of up to about 30 mol %.

Preferred PTT copolymers contain at least about 85 mol %, at least about 90 mol %, at least about 95 mol %, or at least about 98 mol %, of copolymerized units of trimethylene terephthalate. A suitable poly(trimethylene terephthalate) homopolymer for the invention is commercially available under the trade name Sorona® from E.I, du Pont de Nemours and Company, Wilmington Del.

U.S. Pat. No. 6,277,947 and commonly owned U.S. Pat. No. 7,531,617, granted May 12, 2009 disclose methods for the preparation of PTT.

In the molding resin described herein, the poly(trimethylene terephthalate) homopolymer or copolymer may comprise poly(trimethylene terephthalate) repeat units and end groups and have a cyclic dimer content of less than or equal to 1.1 wt %, determined by nuclear magnetic resonance [“NMR”] analysis and based on the weight of the poly(trimethylene terephthalate) repeat units and the cyclic dimer, as well as an intrinsic viscosity of about 0.9 to about 2.0 dL/g, preferably about 0.9 to about 1.5 dL/g, and about 0.9 to about 1.2 dL/g.

In the preferred molding resin described herein, the cyclic dimer is of the following formula (I)

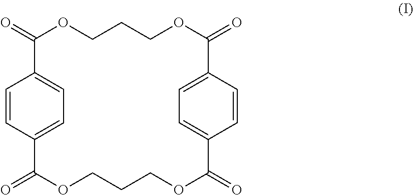

Determination of cyclic dimer content is done by NMR analysis which directly measures the content of all terephthalate groups in the polymer repeat units—including the terephthalate present in any end groups—and, in a separate and distinct region, that of the terepthalate groups of the cyclic dimer. The peak attributed to content of terephthalate groups in the cyclic dimer occurs at about 7.7 ppm, which is distinct from the peak attributed to content of the terephthalate groups in the polymer repeat units at 8.1 ppm.

The molding resin described herein and which has a cyclic dimer content of less than or equal to 1.1 wt % is available by solid state polymerization of PTT, which polymerization comprises the steps of:

providing a molding resin composition in the form of a plurality of pellets having a pellet size of 3.0 to 4.0 g/100 pellets, and having poly(trimethylene terephthalate) repeat units; and
heating and agitating to a condensation temperature and for a condensation time the plurality of pellets,
wherein:
before heating and agitating, the molding resin composition has an initial cyclic dimer content, one or more condensation catalysts, and an intrinsic velocity of 0.50 to 0.89 dL/g; and
after heating and agitating, the molding resin composition has a cyclic dimer content less than equal to 1.1 weight percent, as determined by nuclear magnetic resonance, of the total weight of the poly(trimethylene terephthalate repeat units and the cyclic dimer, and an intrinsic velocity in the range of 0.9 to 2.0 dL/g.

The one or more condensation catalysts are preferably about 25 to about 200 ppm based on the weight of the molding resin composition before heating and agitation. A preferred catalyst is titanium (IV) butoxide.

The heating and agitating of the plurality of pellets may be done in a rotary dryer, fluidized bed, or fluidized column factor in the range of 180° C. and 215° C., and under a reduced pressure of about 0.1 to about 10 mm Hg.

U.S. Pat. No. 7,332,561 discloses an alternative PTT solid state polymerization process.

The poly(trimethylene terephthalate) polymer may be present from about 50 to 98.9 weight percent or from about 70 to about 98.9 weight percent of the toughened PTT composition.

(a-2) Organic Additives

The molding resin may include from 0 to 20 weight percent of one or more organic additives selected from the group consisting of thermoplastic polymers other than the (a-1) polymer, lubricants, flow modifiers, heat stabilizers, antioxidants, dyes, pigments, and UV stabilizers, and the like, so long as the organic additive does not impair either the desired physical properties or the surface properties of the molded article. No undue level of experimentation is required to determine which organic additives are suitable in the compositions described herein as one of skill in the art is sufficiently apprised of suitability from available literature and/or a recognizably predictable level of experimentation.

Suitable thermoplastic polymers other than the poly(trimethylene terephthalate) polymer of (a-1) include polymers selected from the group consisting of polyesters, for instance, poly(ethylene terephthalate) (PET), poly(butylene terephthalate) (PBT), PET copolymer, PBT copolymer; poly(hydroxylalkanoic) (PHA) polymers, for instance poly(lactic acid) (PLA), poly(glycolic acid), poly(hydroxy-butyric acid), poly(6-hydroxyhexanoic acid), poly(3-hydroxyhexanoic acid), poly(4-hydroxyhexanoic acid) poly(3-hydroxyheptanoic acid), polyetheresters, polyetheramides, polyetheresteramides, polyamides, and polycarbonates.

Suitable lubricants include, but are not limited to, Loxiol PTS HOB 7119 available from Cognis, and Licomont ET 132, Licomont ET141, and Licomont wax OP available from Clariant Corp., Charlotte, N.C.

Suitable antioxidants include, but are not limited to, hindered phenol compounds including, for example, tetrakis (methylene (3,5-di-(tert)-butyl-4-hydroxyhydrocinnamate)) methane available commercially as Irganox® 1010 and Irganox 1076, both available from CIBA Specialty Chemicals, Tarrytown, N.Y. Other useful antioxidants include phosphites Ultranox® 626 and Westin® 619, available from GE Specialty Chemical, Morgantown, W. Va., Irgafos® 168 (Tris(2,4-ditert-butylphenyl)phosphite) available from CIBA Specialty Chemicals and Adekastab® P-EPQ and Adekastab® PEP-36 available from Adeka Corporation Tokyo 116-8554, Japan.

(a-3) Ionomer Polymers/Combination of Ionomer Polymers and Acid Copolymers

Ionomer polymers comprise ionic groups that are alkali metal ion carboxylates, for example, sodium carboxylates. Such polymers are generally produced by partially or fully neutralizing the carboxylic acid groups of precursor acid copolymers, as defined herein, for example by reaction with a base. An example of an alkali metal ionomer is a sodium ionomer (or sodium neutralized ionomer), for example a copolymer of ethylene and methacrylic acid wherein all or a portion of the carboxylic acid groups of the copolymerized methacrylic acid units are in the form of sodium carboxylates.

The ionomer polymer described herein comprises an ionomer that is an ionic, neutralized, or partially neutralized derivative of a precursor acid copolymer. An acid copolymer is a polymer comprising copolymerized units of an α-olefin, an α,β-ethylenically unsaturated carboxylic acid, and optionally other suitable comonomer(s), such as an α,β-ethylenically unsaturated carboxylic acid ester.

The precursor acid copolymer, from which the ionomer polymer is derived, comprises copolymerized units of an α-olefin having 2 to 10 carbons and about 5 to about 30 weight percent, about 5 to 25 weight percent, or about 10 to about 25 weight percent, of copolymerized units of an α,β-ethylenically unsaturated carboxylic acid having 3 to 8 carbons, based on the total weight of the precursor acid copolymer.

Suitable α-olefin comonomers include, but are not limited to, ethylene, propylene, 1-butene, 1-pentene, 1-hexene, 1-heptene, 3 methyl-1-butene, 4-methyl-1-pentene, and the like and mixtures of two or more of these α-olefins. Preferably, the α-olefin is ethylene.

Suitable α,β-ethylenically unsaturated carboxylic acid comonomers include, but are not limited to, (meth)acrylic acids, itaconic acids, maleic acids, maleic anhydrides, fumaric acids, monomethyl maleic acids, and mixtures of two or more of these acid comonomers. Preferably, the α,β-ethylenically unsaturated carboxylic acid is selected from (meth)acrylic acid.

The precursor acid copolymers may further comprise copolymerized units of other comonomer(s), such as unsaturated carboxylic acids having 2 to 10, or preferably 3 to 8 carbons, or derivatives of these. Suitable acid derivatives include acid anhydrides, amides, and esters. Esters are preferred. Specific examples of preferred esters of unsaturated carboxylic acids include, but are not limited to, methyl (meth)acrylates, ethyl (meth)acrylates, propyl (meth)acrylates, isopropyl (meth)acrylates, butyl (meth)acrylates, isobutyl (meth)acrylates, tert-butyl (meth)acrylates, octyl (meth)acrylates, undecyl (meth)acrylates, octadecyl (meth)acrylates, dodecyl (meth)acrylates, 2-ethylhexyl (meth)acrylates, isobornyl (meth)acrylates, lauryl (meth)acrylates, 2-hydroxyethyl (meth)acrylates, glycidyl (meth)acrylates, poly(ethylene glycol)(meth)acrylates, poly(ethylene glycol) methyl ether (meth)acrylates, poly(ethylene glycol) behenyl ether (meth)acrylates, poly(ethylene glycol) 4-nonylphenyl ether (meth)acrylates, poly(ethylene glycol) phenyl ether (meth)acrylates, dimethyl maleates, diethyl maleates, dibutyl maleates, dimethyl fumarates, diethyl fumarates, dibutyl fumarates, dimethyl fumarates, vinyl acetates, vinyl propionates, and mixtures of two or more thereof. Examples of preferable suitable comonomers include, but are not limited to, methyl (meth)acrylates, butyl (meth)acrylates, glycidyl (meth)acrylates, vinyl acetates, and mixtures of two or more thereof. Preferably, however, the precursor acid copolymer does not incorporate other comonomers in any significant amount.

Mixtures of precursor acid copolymers are also suitable as long as the properties of the copolymers are within the ranges described herein. For example, two or more dipolymers having differing amounts of copolymerized carboxylic acid comonomer or differing melt indices may be used. Also, a mixture of precursor acid copolymers including a dipolymer and a terpolymer may be suitable.

The precursor acid copolymer may have a melt flow rate (MFR) of about 10 to about 1000 g/10 min, or about 20 to about 500 g/10 min, or about 40 to about 300 g/10 min, or about 50 to about 250 g/10 min, as determined in accordance with ASTM method D1238 at 190° C. and 2.16 kg.

To obtain the ionomers suitable for the compositions described herein, the precursor acid copolymers are neutralized with a base so that the carboxylic acid groups in the precursor acid copolymer react to form carboxylate groups. Preferably, the precursor acid copolymers groups are neutralized to a level of about 40% to about 90%, or about 40% to about 70%, or about 43% to about 60%, based on the total carboxylic acid content of the precursor acid copolymers as calculated or measured for the non-neutralized precursor acid copolymers.

Although any stable cation is believed to be suitable as a counter-ion to the carboxylate groups in an ionomer, in making these compositions, preferred are monovalent cations, such as cations of alkali metals. More preferably, the base is a sodium ion-containing base, to provide a sodium ionomer wherein about 40% to about 90%, or about 40% to about 70%, or about 43% to about 60% of the hydrogen atoms of the carboxylic acid groups of the precursor acid are replaced by sodium cations. The particular level of neutralization of the ionomer is referred to as the neutralization ratio.

The one or more ionomer polymers described herein may comprise an ethylene/methacrylic acid copolymer having about 5 to 25 wt % methacrylic acid repeat units based on the weight of the ethylene/methacrylic acid copolymer; and more particularly, the ethylene/methacrylic acid copolymer has a neutralization ratio of 0.40 to about 0.70.

To obtain the ionomer polymers used herein, the precursor acid copolymers may be neutralized by any conventional procedure, such as disclosed in U.S. Pat. Nos. 3,404,134 and 6,518,365.

The as-neutralized ionomer may have a melt flow rate [MFR] of about 0.1 to about 50 g/10 min or less, or about 0.2 to about 30 g/10 min or less, or about 0.3 to about 25 g/10 min, or about 0.5 to about 10 g/10 min, or about 0.6 to about 5 g/10 min, as determined in accordance with ASTM method D1238 at 190° C. and 2.16 kg.

### (b) Fillers

The compositions described herein may include from 0 to 50 weight percent of one or more fillers, based on the total weight of the composition. The filler is any material commonly used in thermoplastic compositions, such as reinforcing agents, and other fillers. The filler may or may not have a coating on it, for example, a sizing and/or a coating to improve adhesion of the filler to the polymers of the composition. The filler may be organic or inorganic. Suitable fillers are selected from the fillers consisting of (1) minerals, such as clay, sepiolite, talc, wollastonite, mica, and calcium carbonate; (2) of glass in various forms such as fibers, milled glass, solid or hollow glass spheres; (3) of carbon as black or fiber; (4) titanium dioxide; (5) of aramid in the form of short fibers, fibrils or fibrids; (6) of flame retardants, such as antimony oxide, sodium antimonite or a combination of these; and (7) any combination of (1) to (6).

The compositions described herein may comprise any combination of filler (1) to (6) named above, at about 1 to 50 weight percent, or at about 5 to about 45 weight percent, or at about 10 to 40 weight percent, of the total weight of the composition. Examples of fillers used in these compositions include in any combination: wollastonite, mica, talc, glass especially glass fiber, titanium dioxide, and calcium carbonate.

### (c) Group A Polymeric Tougheners

Group A polymeric tougheners are referred to as non-interfering tougheners (NT). They do not have functionality as acids, acid salts, acid anhydrides, or epoxide functional groups which react with (a-1) or (a-3) components, nor do they affect the alkali carboxylate factor (ACF) of the composition, other than by dilution. This means that, since total weight of components (a) and (c) is used to calculate ACF, the sole effect on ACF value by Group A polymeric tougheners (c) is to contribute to the total weight of (a) and (c).

Group A polymeric tougheners are selected from the group consisting of polyolefins including polyethylene, polypropylene, ethylene/alpha-olefin copolymers and ethylene/propylene/diene rubbers; ethylene copolymers; copolyetherester elastomers; and blends selected from the group consisting of polyolefins and ethylene copolymers.

When referring to Group A polymeric tougheners, the term “polyolefins” refers to low density polyethylene (LDPE), high density polyethylene (HDPE), ethylene/octene copolymer and ethylene/propylene/diene (EPDM) rubbers; and the term “ethylene copolymer” refers to polymers comprising radicals from the polymerization of ethylene and one or more other ethylenically unsaturated monomer(s) as disclosed in (i) and (ii) below.

Ethylene copolymers useful as non-interfering tougheners are selected from the group consisting of:
i) an ethylene copolymer of the formula E/X where E is the radical formed from ethylene and comprises 40-90 weight percent of the ethylene copolymer;
X is one or more radicals formed from

CH₂═CH(R¹)—C(O)—OR²
wherein R¹ is H, CH₃ or C₂H₅, preferably H or CH₃, and most preferably H; R² is an alkyl group having 1-8 carbon atoms; vinyl acetate; or a mixture thereof; and wherein X comprises 10-60 weight percent; and
ii) an ethylene copolymer of the formula E/X/Y
wherein E and X are as described above, and Y is a radical formed from monomers selected from the group consisting of acrylonitrile, methacrylonitrile; styrene and carbon monoxide; wherein E is 40-89.5 weight percent; X comprises 10-40 weight percent, and Y comprises 0.5-20 weight percent, of the ethylene copolymer.
   Preferably Y is formed from carbon monoxide. Preferably X comprises 15-35 wt %, and most preferably 20-35 wt % of the ethylene copolymer, and Y comprises 0.5-20 wt %, preferably 2.0-12 wt %, and most preferably 3-8 wt %, of the ethylene copolymer.

U.S. Pat. Nos. 3,766,146, 4,014,624 and 4,725,481 disclose copolyetherester elastomers suitable as Group A polymeric tougheners. These are segmented thermoplastic copolyetherester elastomers containing recurring polymeric long chain ester units derived from carboxylic acids and long chain glycols and short chain ester units derived from dicarboxylic acids and low molecular weight diols. The long chain ester units form the soft segment of the copolyetherester elastomer, and the short chain ester units form the hard segment.

More specifically, such copolyetherester elastomers may comprise a multiplicity of recurring intralinear long chain and short chain ester units connected head-to-tail through ester linkages, said long chain ester units being represented by the formula:

—OGO—C(O)RC(O)— (I)

and said short-chain ester units being represented by the formula:

—ODO—C(O)RC(O)— (II)

wherein:
G is a divalent radical remaining after removal of terminal hydroxyl groups from poly(alkylene oxide) glycols, having a carbon to oxygen ratio of about 2.0-4.3, a molecular weight above about 200 and a melting point below about 60° C. The one or more poly(alkylene oxide)glycols useful in forming the G segment include poly(ethylene oxide)glycol, poly(1,2- or 1,3-propylene oxide)glycol, poly(tetramethylene oxide)glycol, poly(hexamethylene oxide)glycol, an ethylene oxide-propylene oxide block or random copolymer, an ethylene oxide-tetrahydrofuran block or random copolymer, etc. Of these poly(alkylene oxide)glycols, poly(ethylene oxide)glycol is preferable. The number-average molecular weight of the poly(alkylene oxide)glycol is preferably 200-6,000, more preferably 400-4,000.

R is a divalent radical remaining after removal of carboxyl groups from a dicarboxylic acid having a molecular weight less than about 300; and

D is a divalent radical remaining after removal of hydroxyl groups from a low molecular weight diol having a molecular weight less than about 250.

When referring to units in a polymer chain, the term “long chain ester units” refers to the reaction product of long chain glycol with a dicarboxylic acid, and when a repeating unit in the copolyesters, correspond to formula (I) above. The long chain glycols are polymeric glycols having terminal (or as nearly terminal as possible) hydroxyl groups and a molecular weight above about 200 and preferably from about 400-4000. The long chain glycols used to prepare the copolyesters are poly(alkylene oxide) glycols as disclosed above.

When referring to units in a polymer chain, the term “short chain ester units” refers to low molecular weight compounds or polymer chain units that have molecular weights less than about 550 and are made by treating a low molecular weight diol (below about 250) with a dicarboxylic acid to form ester units represented by formula (II) above.

Included among the low molecular weight diols which react to form short chain ester units are acyclic, alicyclic and aromatic dihydroxyl compounds, an example of which is 1,4-butanediol. Dicarboxylic acids which are reacted with the foregoing long chain glycols and low molecular weight diols to produce the copolyesters of this invention are aliphatic, cycloaliphatic or aromatic dicarboxylic acids of low molecular weight, that is, having a molecular weight of less than about 300, an example of which is terephthalic acid.

Examples of specific copolyetherester elastomers useful in the invention are the Hytrel® elastomers available from E.I. du Pont de Nemours and Company, Wilmington, Del.

The Group A polymeric tougheners are used in about 1.0 to about 5 weight percent, preferably 1 to 3 weight percent, based on the total weight of components (a) and (c).

### Properties of the Compositions Described Herein

Suitability of PTT compositions in various applications depends on the properties of the PTT molding resins in the compositions. A first consideration is the crystallization rate of the PTT molding resin. Conventional PTT molding resins typically crystallize relatively slowly from the melt.

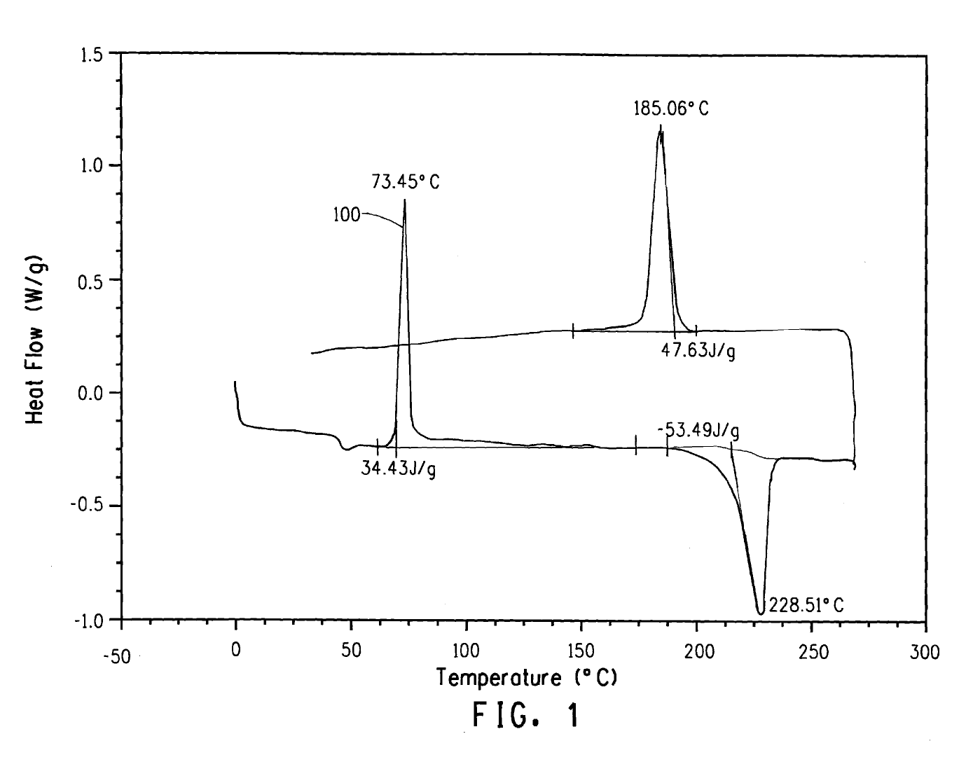

To assess a composition's ability to crystallize, it is typically melted under controlled isothermal conditions to produce a melt. Immersing the melt sample in liquid nitrogen cools it rapidly, a step typically called “melt-quenching” or providing a “melt quenched sample.” FIG. 1 shows a typical DSC scan of a melt quenched sample of a commercial PTT resin without added ionomer compositions. The scan was initiated at 0° C.; heated at 10° C./min scan rate through a recrystallization exotherm (100).

Recrystallization exotherm is a measure in Joules/gram (J/g) of how much crystallization of the PTT composition has NOT occurred in the quenching process. Large exotherms indicate that the crystallization in the PTT composition occurs relatively slowly and that a large fraction of the PIT molding resin did not crystallize in the quench. Large exotherms are typically undesirable for molding resins. Very small recrystallization exotherms, indicative of high degrees of crystallization during quench, are highly desirable for molding resins.

To increase the crystallization rate of PTT molding resins, and thus reduce the cycle time of thermoplastic molding processes, nucleating agents may typically be added to the composition; and ionomers may be added to act as nucleating agents.

Besides crystallization rate, another important consideration for determining whether a PIT molding resin is suitable for certain applications is the hydrolysis resistance of the molded parts made from the PTT composition. Hydrolysis resistance is assessed herein by treating the molded parts of the PTT composition in a Pressure Cooker Test at elevated temperature and pressure for a period of time up to 30 hours. The tensile strength and elongation to break are then determined for the treated samples and compared to those of untreated samples to determine the % retention of tensile strength and elongation to break.

A novel aspect of the PTT compositions described herein is that PTT molding resins in the compositions have a specific compositional range of (a-3) 0.1 to 4 weight percent of one or more ionomer polymers or combination of one or more ionomer polymers and acid polymers, and that the PTT resins exhibit a heretofore unknown rapid crystallization and excellent hydrolysis resistance.

The compositional range is one defined by the following formula (I):

ACF=Σₐ₋ᵢ[(W·Z·N)ₐ₋ᵢ(W·N)ₐ₋ᵢ·100/Σₐ₋ᵢ(W)ₐ₋ᵢ] (I)

wherein each ionomer polymer and acid copolymer has:
a weight percent, W;
a weight fraction of C₃ to C₈ carboxylic acid repeat units, Z, based on the weight of each ionomer or acid copolymer; and
a neutralization ratio, N, equal to any value from 0 to 1.0;
wherein said neutralization ratio N is the mol fraction of the carboxylic acid repeat units neutralized as an alkali metal salt, based on the total carboxylic acid repeat units in the ionomer and acid copolymers; and
   said each ionomer and acid polymer weight percent W is based on the weight of components (a) and (c); wherein said molding resin has an alkali carboxylate factor, ACF, of 4 to about 14, and preferably 4 to 12.

The term (W·Z·N)ₐ₋ᵢ refers to an alkali carboxylate level. The term (W·N)ₐ₋ᵢ/Σᵢ(W)ₐ₋ᵢ is the weight averaged neutralization ratio for the composition; wherein each ionomer polymer and acid copolymer present in a composition is represented by a consecutive letter a-i. The sum contribution of each ionomer polymer and each acid copolymers gives the ACF value. However, the acid copolymers, by definition, have a neutralization ratio of 0, and can contribute only to the Σₐ₋ᵢ(W)_{a-I} term in formula (I). Thus, the ACF value can be affected by the amount of acid copolymer in the molding resin.

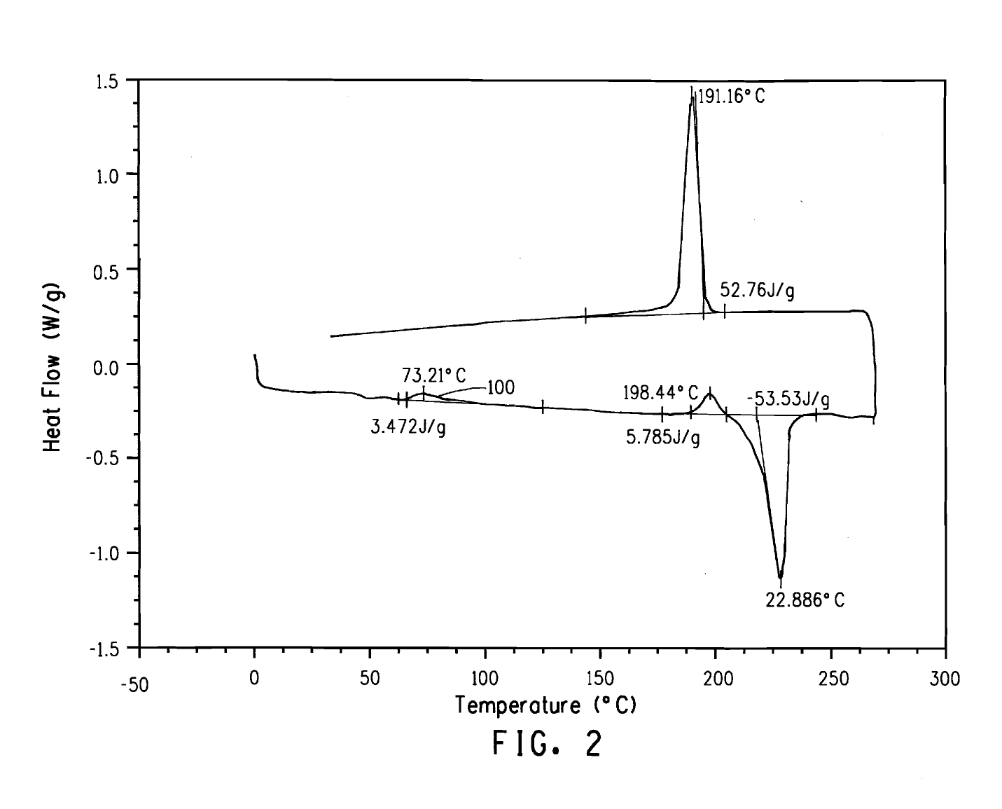

FIG. 2 shows a preferred composition described herein, wherein the composition has an ACF of 5.22 and the recrystallization exotherm (100) is less than 5 J/g.

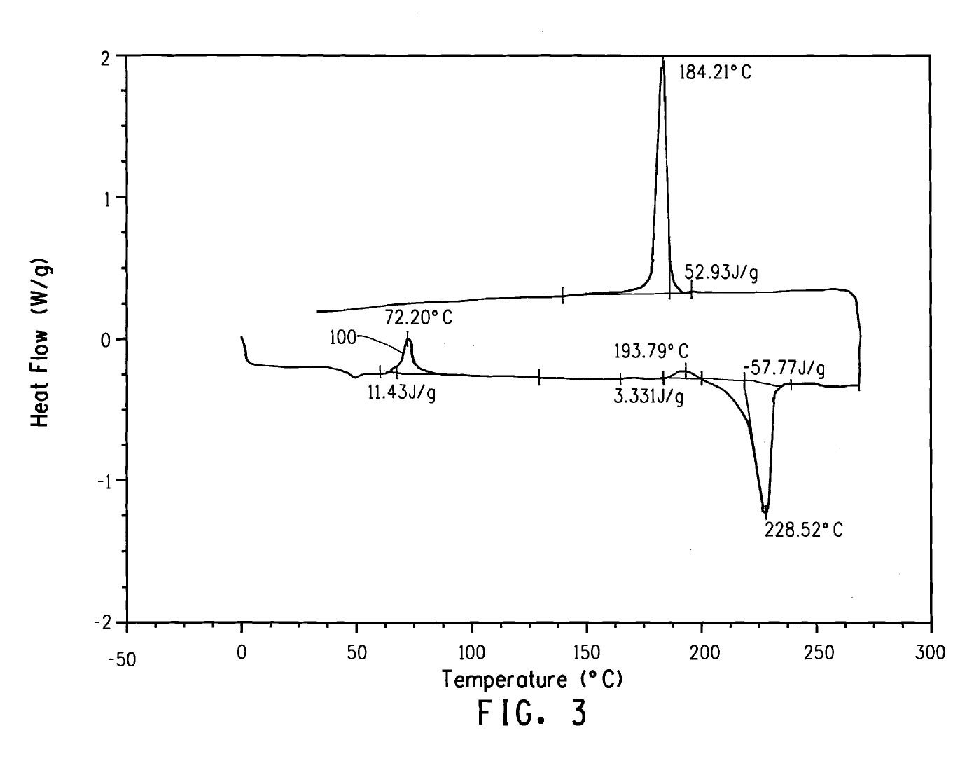

FIG. 3 shows a comparative example wherein the thermoplastic composition has an ACF of 2.6 and the recrystallization exotherm (100) is about 11.4 J/g; a less desirable value than that of the composition of FIG. 2.

The compositions described herein may exhibit a recrystalllization peak of less than 5 J/g as measured with Differential Scanning calorimetry (DSC) at 10° C./min scan rate from a melt quenched sample. Moreover, the compositions described herein may also exhibit greater than about 70% tensile strength retention after a Pressure Cooker Test for 30 h at 121° C. and 2 atm, relative to an untreated molded article, as measured with ISO method 527-1/2.

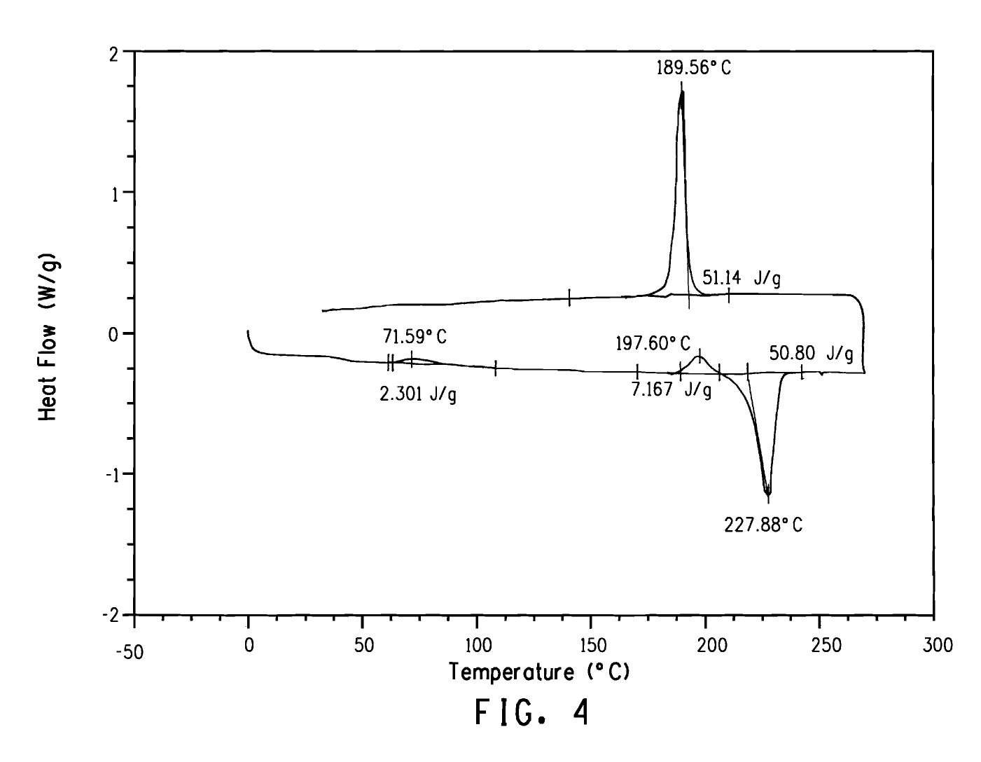

FIG. 4, shows a composition described herein from Example 12, having an ACF of 5.22 and 1.5 wt % Group A polymeric toughener and the recrystallization exotherm (100) being less than 5 J/g, which indicates that the Group A polymeric toughener does not interfere with the nucleation characteristics of these compositions.

### Making the Compositions Described Herein

The compositions of the present invention are in the form of a melt-mixed blend, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method. The component materials may be mixed to homogeneity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until homogeneous. The sequence of mixing in the manufacture of the flame resistant polyester resin composition of this invention may be such that individual components may be melted in one shot, or the filler and/or other components may be fed from a side feeder, and the like, as will be understood by those skilled in the art.

### Articles Comprising the Compositions Described Herein and Processes for Making

The poly(trimethylene terephthalate) resin compositions described herein may be formed into articles using methods known to those of skill in the art, which include injection molding. These articles may be used in electrical, electronic and automotive applications and as mechanical machine parts.

### EXAMPLES AND COMPARATIVE EXAMPLES MATERIALS

### PTT Resin

Sorona® Bright PTT resin was available from E. I. du Pont de Nemours & Co., Inc. Wilmington, Del., USA, having an IV of 1.02 dL/g and 2.7 wt % cyclic dimer.

The following processes were used to prepare PTT resins used in the examples.

PTT-A PTT resin (15 Kg pellets) provided from continuous polymerization of 1,3-propanediol with terephthalic acid in the presence of titanium (IV) n-butoxide (100 ppm) having 33±2 mg per pellet with dimensions 2.9±0.2×2.8±0.2×4.1±0.2 mm, with an intrinsic viscosity of 0.61 dL/g, and with a PTT cyclic dimer concentration of 2.5 weight %, was charged to a dual cone tumble drier (#36 Conaform rotary dryer, Patterson Industries, Toccoa Ga. USA). The tumble drier was rotated at a rate of 6 revolutions per minute while heating at a rate of 36° C./h up to 205° C. under vacuum 1.8 mm Hg (240 Pa) and nitrogen 3.7 L/min. The temperature of the drier was held at 202±2° C. for 14 hours. The dryer was cooled under vacuum until pellet temperature reached 37° C.; the vacuum was broken with nitrogen and the reactor was packed out under positive nitrogen pressure. The dryer was cooled at a rate of 40° C./h to provide PTT-A pellets having an intrinsic viscosity (IV) of 0.88 dL/g; and a cyclic dimer content of about 0.85 wt %.

PTT-B. PTT resin (4682 Kg of pellets, E. I. du Pont de Nemours & Co., Inc. Wilmington, Del., USA) provided from continuous polymerization of 1,3-propanediol with dimethyl terephthalate in the presence of titanium (IV) n-butoxide (100 ppm) having 33±2 mg per pellet with dimensions 2.9±0.2×2.8±0.2×4.1±0.2 mm, with an inherent viscosity of 0.76 dL/g, and with a PIT cyclic dimer concentration of 2.5 weight %, was charged to a dual cone tumble drier (ABBE rotating dryer, model 24, Patterson, N.J., USA) The tumble drier was rotated at a rate of 4 revolutions per minute while heating at a rate of 10° C./h up to 205° C. under vacuum 0.52 mm Hg (69 Pa). The temperature of the drier was held at 205±24° C. for 11 hours. The dryer was cooled under vacuum until pellet temperature reached 60° C.; the vacuum was broken with nitrogen and the reactor was packed out under positive nitrogen pressure. The dryer was cooled at a rate of 25° C./h to provide the solid phase polymerization pellets having a cyclic dimer concentration of 0.82 weight % as determined with NMR and the intrinsic viscosity (IV) of 1.14 dL/g.

PTT-C was a mixture of dry blended pellets of Sorona® Bright PTT resin (IV 1.02 dL/g, 70 parts) and PTT-A pellets (IV 0.88 dL/g, 30 parts) having an IV of 0.92 dL/g.

PIT-D was a mixture of dry blended pellets of Sorona® Bright PTT resin (IV 1.02, 30 parts) and PIT-A pellets (IV 0.88, 70 parts) having an IV of 0.98 dL/g.

Acid polymer-A resin is an ethylene-methacrylic acid copolymer (15 wt % MMA, 0 mol % Na neutralized)

### Ionomers

lonomer-A resin is a neutralized ethylene-methacrylic acid copolymer (19 wt % MAA, 55 mol % Na neutralized).

lonomer-B resin is a neutralized ethylene-methacrylic acid copolymer (15 wt % MAA, 59 mol % Na neutralized)

Ionomer-C resin is a neutralized ethylene-methacrylic acid copolymer (11 wt % MAA, 55 mol % Na neutralized).

Ionomer-D resin is a neutralized ethylene-methacrylic acid copolymer (15 wt % MAA, 60 mol % Zn neutralized).

Ionomer-E resin is a neutralized ethylene-methacrylic acid copolymer (15 wt % MAA, 60 mol % Mg neutralized).

Ionomer-F resin is a neutralized ethylene-methacrylic acid copolymer (15 wt % MAA, 70 mol % Na neutralized)

Ionomer-G resin is a neutralized ethylene-methacrylic acid copolymer (15 wt % MAA, 90 mol % Na neutralized)

Ionomers A-E and Acid polymer-A resin are available from E.I. du Pont de Nemours and Co., Wilmington, Del., under the Surlyn® resin brand and Nucrel® resin brand, respectively. Ionomer-F and G were prepared by synthesis form Ionomer-B.

### Group A Polymeric Tougheners

Listed below are Group A polymeric tougheners, referred to as non-interfering tougheners (NT), used in the examples.

NT-1 is Hytrel® 4056 polyetherpolyester elastomer [Tₘ150° C. and T_{g}−50° C. (10° C./min, ISO 11357-1/-2/-3)] is available from E.I. du Pont de Nemours and Company, Wilmington, Del.

NT-2 refers to Dowlex® 2045, a low density polyethylene available from Dow Chemical, Midland Mich.

NT-3 is an ethylene/methyl acrylate copolymer with 24 weight % methyl acrylate available from E.I. du Pont de Nemours and Company, Wilmington, Del.

NT-4 is an ethylene/n-butyl acrylate copolymer with 27 wt % n-butyl acrylate, available from E.I. du Pont de Nemours and Company, Wilmington, Del.

NT-5 is an ethylene/n-butyl acrylate/carbon monoxide terpolymer containing about 30 weight % of n-butyl acrylate and about 10 weight % of CO available from E.I. du Pont de Nemours and Company, Wilmington, Del.

NT-6 is Engage® 8180 ethylene/octene copolymer from Dow Chemical, Houton, Tex., USA.

NT-7 is Alathon® L5845 high density polyethylene from Lyondell/Basell Industries, Houston, Tex., USA.

NT-8 is ethylene/vinyl acetate with 40 wt % vinyl acetate available from E.I. du Pont de Nemours and Company, Wilmington, Del.

### Other Constituents

### Fillers and Other Additives

Irganox® 1010 antioxidant is available from Ciba Specialty Chemicals, Inc., Tarrytown, N.Y.

C-Black refers to RYNRE5334 BKC, a concentrate pellet of 52.5 weight % polyethylene carrier and 47.5 weight % carbon black manufactured by Clariant Corp., Charlotte, N.C.

Licomont ET141 is a pentaerythritol tetramontanate mold release lubricant available from Clariant Corp. (Charlotte, N.C. 28205, USA).

PTS HOB7119 is a pentaerythritol tetrastearate available from Cognis, Inc. Wax OP is a lubricant manufactured by Clariant Corp., Charlotte, N.C. Plasthall® 809 is polyethylene glycol 400 di-2-ethylhexoate available from C.P. Hall Company, Chicago, Ill. 60606.

### Methods

### Sample Preparation and Physical Testing

The compositions of the Examples and Comparative Examples were molded into 4 mm ISO all-purpose bars. The test pieces were used to measure mechanical properties on samples at 23° C. and dry as molded. The following test procedures were used and the results are given in Table 1-4:

| | |
|---|---|
| Tensile strength and elongation at break: | ISO 527-1/2 |
| Notched Izod impact | ISO 180-1A |

### Pressure Cooker Test

Test bars were also conditioned in an autoclave at 121° C., 2 atm, and 100% relative humidity for 30 hours. Mechanical properties were measured on the conditioned test bars and the results were compared to the properties of the unconditioned bars. The mechanical properties of the conditioned bars and the percentage retention of the physical properties are given in Tables 1-3. A greater retention of physical properties indicates better hydrolysis resistance.

### Intrinsic Viscosity

The intrinsic viscosity (IV) of the PTT resin was determined using viscosity measured with a Viscotek Forced Flow Viscometer Y-501 (Viscotek Corporation, Houston, Tex.) for the polymers dissolved in 50/50 weight % trifluoroacetic acid/methylene chloride at a 0.4 grams/dL concentration at 19° C. following an automated method based on ASTM D 5225-92. The measured viscosity was then correlated with standard viscosities in 60/40 wt % phenol/1,1,2,2-tetrachloroethane as determined by ASTM D 4603-96 to arrive at the reported intrinsic values.

### Determination of Cyclic Dimer Content by NMR

4-6 pellets of PTT were melt pressed at 260° C. and melted for 5 minutes and subsequently pressed to 10,000 lbs of pressure to create a thin film (0.14 mm thick) to increase the surface area of the polymer for easy dissolution. The pressed film of polymer (15 mg) was added to CDCl₃/TFA-d (5:1, 1 mL) mixture and dissolved. The solution was transferred to a 5 mm NMR tube and analyzed within one hour of sample preparation. 64 scans were run at 30° C. with a 16 second delay time on a Varian INOVA 500 MHz NMR with a proton/fluorine/carbon probe. The obtained spectrum was integrated at the terephthalate region (8.1 ppm) and the cyclic dimer region (7.65 ppm). The weight percent of cyclic dimer is calculated by dividing the integration value of the cyclic dimer region by the sum of the integration values of the cyclic dimer region and the terephthalate region multiplied by 100.

### Differential Scanning Calorimetry (DSC)

A Differential scanning calorimeter, TA Instruments Q1000 MDSC (Modulated DSC) operating in “Standard Mode” was used to determine the recrystalllization peak in a melt quenched sample of the thermoplastic composition. A 10-12 mg sample of the composition was weighed into an aluminum DSC pan and the sample heated to 270° C. in a DSC for 10 minutes under nitrogen atmosphere to provide an equilibrated melt sample. The melt sample was remove from the DSC and quick quenched by immersing the sample in liquid nitrogen. The melt quenched sample was equilibrated at 0° C. in the DSC under nitrogen atmosphere, followed by heating at 10° C./min scan rate to 270° C.; held at isothermal for 3 min at 270° C., and cooled at 10° C./min scan rate to 30° C.; while recording the thermal events. The recrystallization peak is the first exothermic peak exhibited in the heating cycle, having a peak height maximum at about 65-75° C. The enthalpy of the recrystallization peak was measured in Joules per gram (J/g).

### Results

Components listed in Tables 1-4, for Examples and Comparative Examples, with the exception of Plasthall® 809, were combined and fed to the rear of a ZSK 40 mm twin screw extruder and melt mixed using at a melt temperature of about 260° C. to yield a resin composition. Plashtall® 809 was added into the die position of the extruder using liquid injection pump line. Exiting the extruder, the compositions were passed through a die to form strands that were cooled and solidified in a quench tank and subsequently chopped to form pellets. The compositions were molded into test specimens and tested according to the methods outlined above.

Comparative Example C-1 is a PTT molding resin composition containing no ionomer polymer and having a very large recrystallization exotherm peak (39.9 J/g).

Examples 1-11 exhibit an ACF of between 4 and 12, recrystallization exotherms all less than 5 J/g, and Tensile strength retention of greater than about 66% in the Pressure Cooker Test. Comparative Example C-2, C-3, C-4 and C-5 exhibit an ACF below 4, recrystallization exotherms greater than 5, and for C-3, greater than about 20 J/g. ACF below 4, therefore, tends to lead to higher, not desirable recrystallization exotherms.

Comparative Examples C-6, C-9, and C-10 exhibit an ACF higher than 14-26, 14.7 and 18.2, respectively—and tensile strength retention of 43% or less in the Pressure Cooker Test.

Comparative Examples C-7 and C-8 having ionomers with zinc or magnesium as the neutralization counter ions do not show desirable reductions in recrystallization exotherms.

TABLE 1

| Example No. | C-1 | 1 | 2 | 3 | C-2 | 4 | 5 | C-3 | 6 | 7 |
|---|---|---|---|---|---|---|---|---|---|---|
| PTT-B | 98.50 | 97.50 | 97.00 | 96.50 | 97.50 | 96.50 | 95.50 | 95.50 | 96.00 | 95.10 |
| Wax OP | 0.20 | 0.20 | 0.20 | 0.20 | 0.20 | 0.20 | 0.20 | 0.20 | 0.20 | 0.20 |
| Acid polymer-A | | | | | | | | 1.50 | | |
| Ionomer-A | | | | | 1.00 | 2.00 | 3.00 | | | |
| Ionomer-B | | 1.00 | 1.50 | 2.00 | | | | 1.50 | 1.50 | 1.50 |
| Irganox ® 1010 | 0.30 | 0.30 | 0.30 | 0.30 | 0.30 | 0.30 | 0.30 | 0.30 | 0.30 | 0.20 |
| C-Black | 1.00 | 1.00 | 1.00 | 1.00 | 1.00 | 1.00 | 1.00 | 1.00 | 1.00 | 1.00 |
| Plasthall 809 | | | | | | | | | 1.00 | 2.00 |
| Total Production (%) | 100.00 | 100.00 | 100.00 | 100.00 | 100.00 | 100.00 | 100.00 | 100.00 | 100.00 | 100.00 |
| Properties | | | | | | | | | | |
| Tensile Strength | 64.792 | 65.938 | 66.286 | 66.328 | 65.781 | 65.075 | 64.502 | 62.650 | 62.028 | 59.203 |
| (Mpa) Control | | | | | | | | | | |
| Elongation at Break (%) | 15.91% | 20.93% | 19.91% | 19.70% | 20.48% | 20.24% | 21.14% | 18.66% | 18.50% | 20.59% |
| Control | | | | | | | | | | |
| Tensile Strength (Mpa) | 62.181 | 59.061 | 52.768 | 52.494 | 55.626 | 48.523 | 44.992 | 50.962 | 47.521 | 46.981 |
| 30 h PCT | | | | | | | | | | |
| Elongation at Break (%) | 12.96% | 9.07% | 3.81% | 3.27% | 5.93% | 2.64% | 2.16% | 3.98% | 3.69% | 4.99% |
| 30 h PCT | | | | | | | | | | |
| Recrystallization peak (J/g) | 38.90 | 3.90 | 3.27 | 3.46 | 5.71 | 4.77 | 3.72 | 20.3 | 4.22 | 2.21 |
| Sum of alkali | 0.0000 | 0.0885 | 0.1328 | 0.1770 | 0.0855 | 0.1710 | 0.2565 | 0.1328 | 0.1328 | 0.1328 |
| carboxylate level | | | | | | | | | | |
| Weight Averaged | 0.0000 | 59.0000 | 59.0000 | 59.0000 | 45.0000 | 45.0000 | 45.0000 | 29.5000 | 59.0000 | 59.0000 |
| Neutralization Ratio × 100 | | | | | | | | | | |
| ACF* | 0.0000 | 5.2215 | 7.8323 | 10.4430 | 3.8475 | 7.6950 | 11.5425 | 3.9161 | 7.8323 | 7.8323 |
| 30 h PCT TS retention (%) | 95.97 | 89.57 | 79.61 | 79.14 | 84.56 | 74.56 | 69.75 | 81.34 | 76.61 | 79.40 |
| 30 h PCT El retention (%) | 81.46% | 43.33% | 19.14% | 16.60% | 28.96% | 13.04% | 10.22% | 21.33% | 19.95% | 24.24% |

*ACF = alkali carboxylate factor calculated from formula 1.

TABLE 2

| Example No. | 8 | 9 | 10 | C-4 | 11 | C-5 | C-6 | C-7 | C-8 |
|---|---|---|---|---|---|---|---|---|---|
| PTT-B | | 96.45 | 97.50 | 96.50 | 97.00 | 95.50 | 89.50 | 97.0 | 97.0 |
| Wax OP | | 0.20 | 0.20 | 0.20 | 0.20 | 0.20 | 0.20 | 0.2 | 0.2 |
| Acid Polymer-A | | | | 1.00 | | 1.50 | | | |
| Ionomer-C | | 2.05 | | | | | | | |
| Ionomer-B | | | 1.00 | 1.00 | 1.50 | 1.50 | 5.00 | | |
| Ionomer-D | | | | | | | | 1.5 | |
| Ionomer-E | | | | | | | | | 1.5 |
| Irganox ® 1010 | | 0.30 | 0.30 | 0.30 | 0.30 | 0.30 | 0.30 | 0.3 | 0.3 |
| C-Black | | 1.00 | 1.00 | 1.00 | 1.00 | 1.00 | 1.00 | 1.0 | 1.0 |
| Plasthall 809 | | | | | | | 4.00 | | |
| Total Production (%) | 100.00 | 100.00 | 100.00 | 100.00 | 100.00 | 100.00 | 100.00 | 100 | 100 |
| Properties | 97.14 | | | | | | | | |
| Tensile Strength (Mpa) Control | 0.20 | 56.350 | 66.336 | 64.248 | 65.545 | 62.940 | 51.846 | 62.5 | 61.4 |
| Elongation at Break (%) Control | | 15.90 | 18.80 | 18.60 | 19.10 | 19.00 | 23.30 | 19 | 18.4 |
| Tensile Strength (Mpa) 30 h PCT | 1.36 | 37.00 | 55.60 | 56.20 | 50.10 | 50.30 | 22.40 | 43.5 | 48.2 |
| Elongation at Break (%) 30 h PCT | | 2.6 | 3.8 | 5.3 | 2.6 | 3.4 | 1.4 | 3.2 | 3.6 |
| 30 h PCT TS retention (%) | | 66 | 84 | 87 | 76 | 80 | 43 | 70 | 79 |
| 30 h PCT El retention (%) | | 16 | 20 | 28 | 14 | 18 | 6 | 17 | 20 |
| Recrystallization peak (J/g) | 0.30 | 0.00 | 3.50 | 11.40 | 3.30 | 10.90 | 0.00 | 40.8 | 39.8 |
| Sum of alkali carboxylate level | 1.00 | 0.1308 | 0.0885 | 0.0885 | 0.1328 | 0.1328 | 0.4425 | | |
| Weight Averaged Neutralization Ratio × 100 | 55.0000 | 55.0000 | 59.0000 | 29.5000 | 59.0000 | 29.5000 | 59.0000 | | |
| ACF* | 4.7722 | 7.1935 | 5.2215 | 2.6108 | 7.8323 | 3.9161 | 26.1075 | | |

*ACF = alkali carboxylate factor calculated from formula 1.

TABLE 3

Example No.

| | C-9 | C-10 |
|---|---|---|
| PTT-B | 96.5 | 97.0 |
| Wax OP | 0.2 | 0.2 |
| Ionomer-F | 2 | |
| Ionomer-G | | 1.5 |
| Irganox ® 1010 | 0.3 | 0.3 |
| C-Black | 1.0 | 1.0 |
| Total Production (%) | 100 | 10 |
| Properties | | |
| Tensile Strength (Mpa) Control | 67 | 68 |
| Elongation at Break (%) Control | 21 | 21 |
| Tensile Strength (Mpa) 30 h PCT | 26.9 | 25.7 |
| Elongation at Break (%) 30 h PCT | 1 | 1 |
| 30 h PCT TS retention (%) | 40 | 38 |
| 30 h PCT El retention (%) | 5 | 5 |
| Recrystallization peak (J/g) | 5.48 | 4.83 |
| Sum of alkali carboxylate level | 0.21 | 0.20 |
| Weight Averaged Neutralization Ratio × 100 | 70 | 90 |
| ACF* | 14.7 | 18.2 |

*ACF = alkali carboxylate factor calculated from formula 1.

TABLE 4

| Example No. | C-11 | 12 | 13 | 14 | 15 | 16 | 17 | 18 | 19 |
|---|---|---|---|---|---|---|---|---|---|
| PTT-C | 98.3 | 96.8 | 96.8 | 96.8 | 96.8 | 96.8 | 96.8 | 96.8 | 96.8 |
| Ionomer B | 1.0 | 1.0 | 1.0 | 1.0 | 1.0 | 1.0 | 1.0 | 1.0 | 1.0 |
| NT-1 | | 1.5 | | | | | | | |
| NT-2 | | | 1.5 | | | | | | |
| NT-3 | | | | 1.5 | | | | | |
| NT-4 | | | | | 1.5 | | | | |
| NT-5 | | | | | | 1.5 | | | |
| NT-6 | | | | | | | 1.5 | | |
| NT-7 | | | | | | | | 1.5 | |
| NT-8 | | | | | | | | | 1.5 |
| Irganox 1010 | 0.20 | 0.20 | 0.20 | 0.20 | 0.20 | 0.20 | 0.20 | 0.20 | 0.20 |
| PTS HOB7119 | 0.50 | 0.50 | 0.50 | 0.50 | 0.50 | 0.50 | 0.50 | 0.50 | 0.50 |
| Tensile Strength (Mpa) | 66.5 | 66.7 | 67.7 | 65.8 | 65.0 | 63.8 | 67.2 | 66.5 | 65.7 |
| Elongation (Strain to break %) | 4.7% | 13.5% | 11.1% | 11.9% | 12.9% | 14.1% | 13.0% | 10.5% | 14.8% |
| Tensile Strength (Mpa) 30 h PCT | 36.9 | 37.9 | 46.7 | 42.2 | 47.0 | 34.8 | 46.3 | 49.4 | 47.1 |
| Elongation at Break (%) 30 h PCT | 1.42% | 1.57% | 1.97% | 1.72% | 1.95% | 1.37% | 1.91% | 2.12% | 1.95% |
| 30 h PCT TS retention (%) | 55 | 57 | 69 | 64 | 72 | 55 | 69 | 74 | 72 |
| 30 h PCT El retention (%) | 30 | 12 | 18 | 15 | 15 | 10 | 15 | 20 | 13 |
| Notched Izod (KJ/M²) | 2.8 | 3.2 | 4.6 | 4.4 | 4.6 | 3.8 | 3.8 | 2.9 | 4.3 |
| Recrystallization peak (J/g) | 2.50 | 2.30 | 3.10 | 2.50 | 2.60 | 2.70 | 3.30 | 3.50 | 3.30 |
| ACF* | 5.22 | 5.22 | 5.22 | 5.22 | 5.22 | 5.22 | 5.22 | 5.22 | 5.22 |

*ACF = alkali carboxylate factor calculated from formula 1.

Comparative Examples C-11 and Examples 12-19 show the affect of mall amounts of a variety of Group A non-interfering tougheners in the compositions. Examples 12-19 indicate that the addition of non-interfering toughener can improve the Notched Izod impact strength over comparative example C-11; while maintaining very low recrystallization exotherms. This indicates that the Group A non-interfering tougheners do not interfere with the nucleation properties of the ionomer/acid polymer also present in the compositions.

What is claimed is:

1. A poly(trimethylene terephthalate) composition comprising
(a) a molding resin comprising
(a-1) a poly(trimethylene terephthalate) polymer consisting of homopolymer or copolymer;
(a-2) optionally, 0.1 to 20 weight percent of one or more organic additives selected from the group consisting of thermoplastic polymers other than the (a-1) polymer, lubricants, flow modifiers, plasticizers, heat stabilizers, antioxidants, dyes, pigments, and UV stabilizers;
(a-3) 0.1 to 4 weight percent of one or more ionomer polymers or a combination of one or more ionomer polymers and acid copolymers;
(b) 0 to 50 weight percent of one or more fillers, based on the total weight of the molding resin;
(c) about 1.0 to 5 weight percent of one or more Group A polymeric tougheners selected from the group consisting of polyolefins, ethylene copolymers, copolyetherester elastomers, and blends of the polyolefins and the ethylene copolymers, based on the total weight of components (a) and (c),
wherein:
the ionomer polymers and the acid copolymers have C₃ to C₈ carboxylic acid repeat units;
each ionomer polymer and acid copolymer has
a weight percent, W, based on the weight of components (a) and (c);
a weight fraction of C₃ to C₈ carboxylic acid repeat units, Z, based on the weight of each ionomer polymer or acid copolymer; and
a neutralization ratio, N, equal to any value from 0 to 1.0 and being the mole fraction of the carboxylic acid repeat units neutralized as an alkali metal salt, based on the total carboxylic acid repeat units in the ionomer polymers and the acid copolymers;
the molding resin has an alkali carboxylate factor, ACF, of 4 to about 14; and
the ACF is defined by the formula:
CF=Σₐ₋ᵢ[(W·Z·N)ₐ₋ᵢ(W·N)ₐ₋ᵢ·100/Σₐ₋ᵢ(W)ₐ₋ᵢ].

2. The poly(trimethylene terephthalate) composition of claim 1, wherein the composition exhibits a recrystallization peak of less than 5 J/g as measured with Differential Scanning calorimetry at 10° C./min scan rate from a melt quenched sample.

3. The poly(trimethylene terephthalate) composition of claim 1, wherein the one or more Group A polymeric tougheners are selected from the group consisting of (1) polyolefins, including polyethylene, polypropylene, ethylene/alpha-olefin copolymers and ethylene/propylene/diene rubbers; (2) ethylene copolymers; (3) copolyetherester elastomers; and (4) blends of (1) and (2).

4. The poly(trimethylene terephthalate) composition of claim 1, wherein the one or more Group A polymeric tougheners is an ethylene copolymer selected from the group consisting of:
(1) an ethylene copolymer of the formula E/X wherein:
E comprises 40 to 90 weight percent of the ethylene copolymer, and is the radical formed from ethylene; and
X comprises 10 to 60 weight percent of the ethylene copolymer, and is one or more radicals formed from vinyl acetate;
CH₂═CH(R¹)—C(O)—OR², wherein:
R¹ is H, CH₃ or C₂H₅, preferably H or CH₃, and most preferably H;
R² is an alkyl group having 1-8 carbon atoms; or a mixture of these;
and
(2) an ethylene copolymer of the formula E/X/Y, wherein:
E is 40 to 89.5 weight percent of the ethylene copolymer, and is the E radical of (1);
X comprises 10 to 40 weight percent of the ethylene copolymer, and is one or more X radicals of (1); and
Y comprises 0.5 to 20 weight percent of the ethylene copolymer, and is a radical formed from monomers selected from the group consisting of acrylonitrile, methacrylonitrile, styrene, carbon monoxide, and mixtures of these.

5. The poly(trimethylene terephthalate) composition of claim 1, wherein the poly(trimethylene terephthalate) polymer has:
poly(trimethylene terephthalate) repeat units and end groups;
a cyclic dimer content of less than or equal to 1.1 wt %, as determined by nuclear magnetic resonance analysis, based on the weight of the poly(trimethylene terephthalate repeat units and the cyclic dimer;
and
an intrinsic viscosity of 0.9 to 2.0 dL/g.

6. The poly(trimethylene terephthalate) composition of claim 1, wherein the one or more ionomer polymers comprise an ethylene/methacrylic acid copolymer having 5 to 25 wt % methacrylic acid repeat units based on the weight of the ethylene/methacrylic acid copolymer.

7. The poly(trimethylene terephthalate) composition of claim 6, wherein the ethylene/methacrylic acid copolymer has a neutralization ratio of 0.40 to 0.70.

8. The poly(trimethylene terephthalate) composition of claim 1, wherein the one or more fillers is selected from: (1) minerals, such as clay, sepiolite, talc, wollastonite, mica, and calcium carbonate; or (2) glass in the form of fibers, milled glass, solid glass spheres and hollow glass spheres; or (3) carbon in the form of carbon black or fiber; or (4) titanium dioxide; or (5) aramid in the form of short fibers, fibrils or fibrids; or (6) flame retardants in the form of antimony oxide, sodium antimonite, and a combination of these; and any combination of (1), (2), (3), (4), (5), and (6).

9. A molded article comprising the poly(trimethylene terephthalate) composition of claim 1.
